(19) United States
(12) Patent Application Publication
(10) Pub. No.: US 2016/0112947 A1
(43) Pub. Date: Apr. 21, 2016

(54) METHOD AND APPARATUS TO IMPROVE WIRELESS DEVICE PERFORMANCE

(71) Applicant: QUALCOMM Incorporated, San Diego, CA (US)

(72) Inventors: Hemant Kumar Sahoo, Hyderabad (IN); Sunit Pujari, Hyderabad (IN); Imran Ansari, Hyderabad (IN); Sougat Ray, Rourkela (IN)

(21) Appl. No.: 14/517,127

(22) Filed: Oct. 17, 2014

(51) Int. Cl. H04W 52/02; H04W 48/08; H04W 28/02; H04W 4/00

(52) U.S. Cl. CPC H04W 52/0206; H04W 52/0232; H04W 4/008; H04W 48/08; H04W 28/0221; H04W 88/06

(57) ABSTRACT

A method and apparatus are disclosed for reducing power consumption of wireless devices operating in a wireless network. In one embodiment, a first wireless device may establish a BLUETOOTH low energy (BLE) connection and a Wi-Fi connection with a second wireless device. The first wireless device may detect Wi-Fi activity and may operate in a low-power mode when no Wi-Fi activity is detected. The first wireless device may receive a synchronized BLE message and may enter a normal operating mode and leave the low-power mode based, at least in part, on the synchronized BLE message. In another embodiment, the first wireless device may operate a scheduler to schedule communications between the second wireless device and a third wireless device. The first wireless device may suspend operation of the scheduler based, at least in part, on a received synchronized BLE message from the second wireless device.

### TECHNICAL FIELD

The present embodiments relate generally to wireless devices, and specifically to improving wireless device performance.

### BACKGROUND OF RELATED ART

Wireless devices may be organized into wireless networks including two or more wireless devices. When a wireless network is operating in an infrastructure mode, the associated wireless devices may operate as an access point (AP) and/or as a station (STA). The AP manages administration of the wireless network by, for example, sending periodic beacon signals, admitting other wireless devices to the wireless network, forwarding associated messages, and the like. When the wireless network is operating in an ad hoc or peer-to-peer mode, a group owner may assist in managing the wireless network in a manner similar as described for the AP.

Some wireless devices may consume power when administering a wireless network, even when there is little or no network traffic. For example, APs and group owners may periodically transmit (e.g., broadcast) a Wi-Fi beacon during each beacon period. Transmitting the Wi-Fi beacon and actively listening for any Wi-Fi messages that may be sent in response to the Wi-Fi beacon consumes power, even when there are no active wireless devices connected to the wireless network. When the access point or group owner is a mobile wireless device, power consumption may undesirably decrease battery life.

Some wireless devices may be connected to a wireless network and another wireless device at approximately the same time. For example, a first wireless device may be coupled to an AP associated with a network operating in the infrastructure mode, and may also be coupled to a second wireless device associated with a network operating in a peer-to-peer mode. The first wireless device may alternate communications between the AP and the second wireless device. For example, the first wireless device may schedule a first time period to transmit/receive messages to/from the AP, and may schedule a second time period to transmit/receive messages to/from the second wireless device. However, if the AP or the second wireless device is idle (e.g., the AP and/or the second wireless device has little or no network traffic), then at least one of the scheduled time periods may be unnecessary. In this scenario, the first wireless device may unnecessarily consume power supporting an idle connection. Moreover, bandwidth allocated to the idle device may be wasted.

Thus, there is a need to reduce the power consumption of a wireless device, particularly when there is little or no network traffic to or from the wireless device.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Devices and method for improving wireless device performance are disclosed. In accordance with the present embodiments, a first wireless device may establish a Wi-Fi connection with a second wireless device and operate in a normal operating mode. The first wireless device may detect Wi-Fi activity associated with the Wi-Fi connection. The first wireless device may leave the normal operating mode and may operate in a low-power mode based, at least in part, on the detected Wi-Fi activity.

In other embodiments, a first wireless device may establish a BLUETOOTH low energy (BLE) connection and a Wi-Fi connection with a second wireless device. The first wireless device may operate a scheduler to schedule Wi-Fi communication between the first wireless device and the second wireless device and between the first wireless device and a third wireless device. The first wireless device may receive a BLE message from the second wireless device. The first wireless device may determine scheduler operation based, at least in part, on the received BLE message.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example wireless network within which the present embodiments may be implemented.

FIG. 2 shows a wireless device that is one embodiment of the access point and/or the station of FIG. 1.

FIG. 3 shows a wireless device that is another embodiment of the access point and/or the station of FIG. 1.

FIG. 4 shows an illustrative flow chart depicting an example operation for operating the wireless system of FIG. 1, in accordance with some embodiments.

FIG. 5 shows an example sequence diagram for operating a scheduler of a wireless device, in accordance with some embodiments.

FIG. 6 shows an illustrative flow chart depicting another example operation for operating the wireless system of FIG. 1, in accordance with some embodiments.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms “wireless local area network (WLAN)” and “Wi-Fi” can include communications governed by the IEEE 802.11 standards, BLUETOOTH®, HiperLAN (a set of wireless standards, comparable to the IEEE 802.11 standards, used primarily in Europe), and other technologies used in wireless communications. Further, the terms “low-power mode” may refer to a low-power operating mode in which one or more components of a Wi-Fi device or station are deactivated (e.g., to prolong battery life), and thus the terms “low-power mode” and “low-power state” may be used interchangeably herein.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

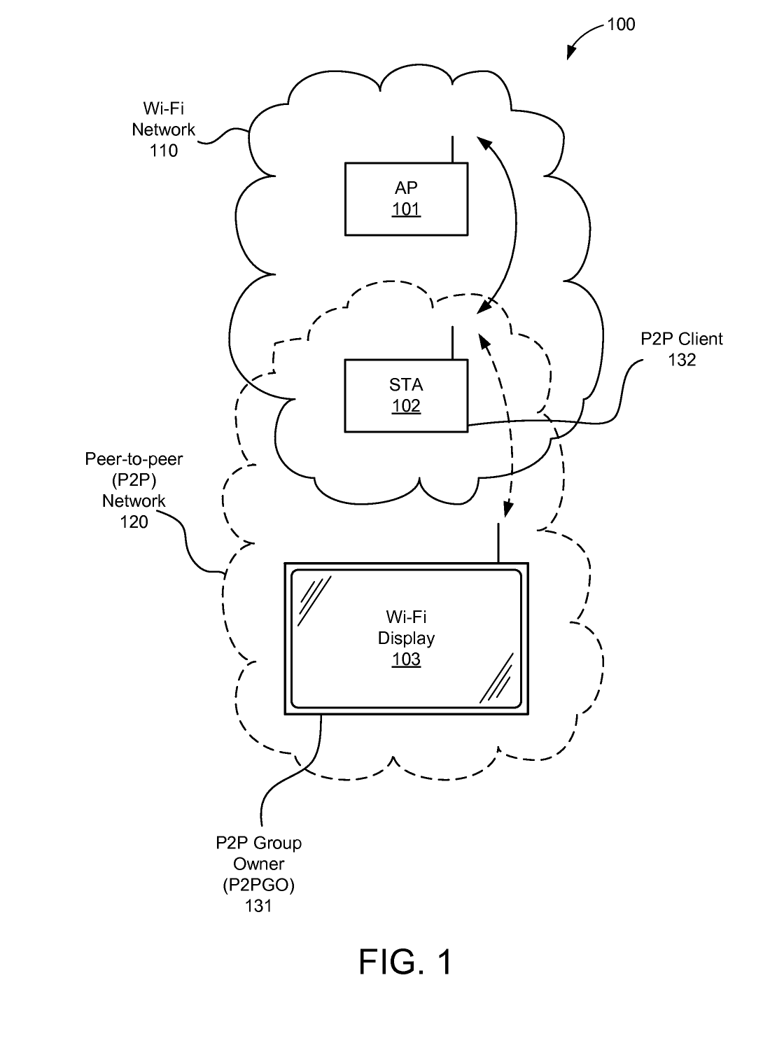

FIG. 1 depicts an example wireless system 100 within which the present embodiments may be implemented. Wireless system 100 includes an access point (AP) 101, a station (STA) 102, and a Wi-Fi display 103. AP 101, STA 102, and Wi-Fi display 103 may be wireless devices and may include Wi-Fi transceivers (not shown for simplicity) to transmit and receive Wi-Fi messages. In other embodiments, wireless system 100 may include other numbers of wireless devices.

In some embodiments, AP 101 may manage a Wi-Fi network 110 (shown in FIG. 1 with solid lines). AP 101 may be a dedicated AP or may be provided via a “soft” AP program executed on a device such as a laptop computer, tablet computer, smartphone or the like. In one embodiment, Wi-Fi network 110 may operate in an infrastructure mode and may include AP 101 and STA 102. AP 101 may perform administrative tasks for Wi-Fi network 110. Example administrative tasks may include verifying STA credentials, forwarding Wi-Fi messages to associated STAs and/or to other networks, broadcasting periodic Wi-Fi beacons, and the like. For example, STA 102 may join Wi-Fi network 110 by providing appropriate credentials to AP 101. Example STAs 102 may include laptop computers, smartphones, desktop computers, tablet computers, or the like. After becoming a member of Wi-Fi network 110, STA 102 may transmit and receive Wi-Fi messages to and from AP 101. For simplicity, Wi-Fi network 110 includes two wireless devices. In other embodiments, Wi-Fi network 110 may include other numbers of wireless devices. In still other embodiments, wireless system 100 may include other numbers of Wi-Fi networks.

In some embodiments, wireless system 100 may include a peer-to-peer (P2P) network 120 (shown in FIG. 1 with dashed lines). P2P network 120 may also be referred to as an ad hoc network or a Wi-Fi direct network. P2P network 120 may operate in a peer-to-peer mode and may include STA 102 and Wi-Fi display 103. While P2P network 120 may lack an AP to perform network administrative tasks, one of the wireless devices in P2P network 120 may operate as a network administrator. For example, Wi-Fi display 103 may operate as the network administrator for the P2P network 120, and thus may be referred to as a P2P Group Owner (P2PGO) 131. Other members of P2P network 120 may be referred to as P2P clients, for example, such as P2P client 132. For simplicity, P2P network 120 includes one P2P client 132. In other embodiments, P2P network 120 may include other numbers of P2P clients 132.

Wi-Fi messages may be transmitted within P2P network 120 between STA 102 and Wi-Fi display 103. For example, STA 102 may stream display data, such as display data stored in STA 102, to Wi-Fi display 103. In some embodiments, the P2PGO 131 may admit other wireless devices (not shown for simplicity) to P2P network 120. P2PGO 131 may also broadcast periodic Wi-Fi beacons (e.g., beacons for P2P network 120). In other embodiments, wireless system 100 may include other numbers of P2P networks.

After transmitting the Wi-Fi beacon, AP 101 or P2PGO 131 may also receive Wi-Fi messages transmitted by other wireless devices (not shown for simplicity) in response to receiving the Wi-Fi-beacon. If there is no Wi-Fi network traffic (because, for example, there are no STAs or P2P clients within range of the AP 101 and/or P2PGO 131), then the AP 101 and/or P2PGO 131 may unnecessarily consume power transmitting the Wi-Fi beacon and operating the Wi-Fi transceiver to receive Wi-Fi messages.

In some embodiments, STA 102 may be a member of Wi-Fi network 110 and may be a member of P2P network 120 at substantially the same time. For example, STA 102 may be coupled to both AP 101 and Wi-Fi display 103. Therefore, STA 102 may transmit/receive Wi-Fi messages to/from AP 101 and also transmit/receive Wi-Fi messages to/from Wi-Fi display 103. In some embodiments, STA 102 may execute a scheduling program to allow STA 102 to schedule communication time periods between STA 102 and AP 101 and between STA 102 and Wi-Fi display 103. For example, the scheduling program may schedule 40% of an available time period to transmit/receive Wi-Fi messages to/from AP 101, schedule 40% of the available time period to transmit/receive Wi-Fi messages to/from Wi-Fi display 103, and leave 20% of the available time period (the remaining time) for overhead tasks. However, if Wi-Fi network 110 or P2P network 120 becomes idle, then the scheduling program may unnecessarily schedule time for the idle network, which in turn may result in under-utilization of the wireless medium associated with networks 110 and/or 120.

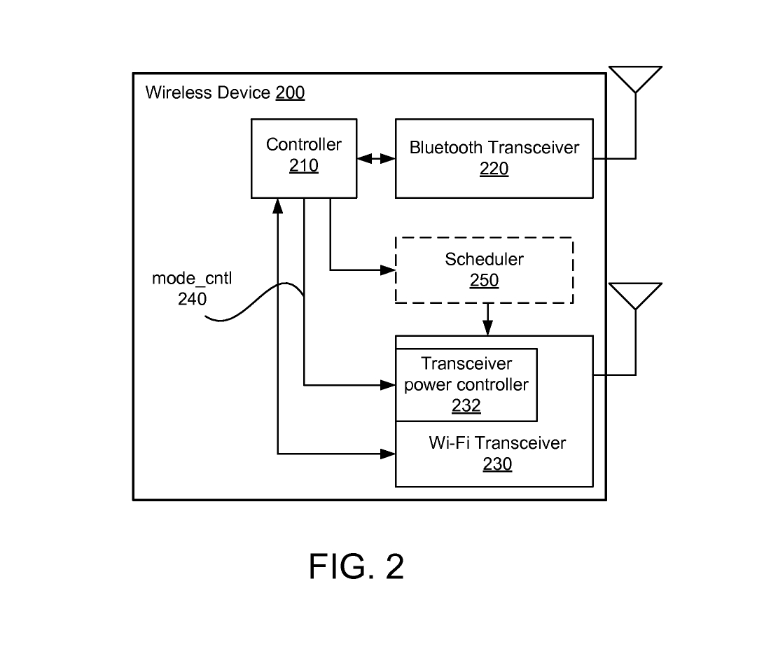

AP 101 and STA 102 may also include a BLUETOOTH® transceiver (not shown for simplicity) to transmit and receive BLUETOOTH messages. In some embodiments, the BLUETOOTH transceivers may also transmit and receive BLUETOOTH Low Energy (BLE) messages. BLE messages may be used to reduce power consumption of a wireless device managing a wireless network and/or a wireless device communicating with other wireless devices. Operation of AP 101 and STA 102 with respect to BLE messages is described in more detail below in conjunction with FIGS. 2-6.

FIG. 2 shows a wireless device 200 that is one embodiment of AP 101 and/or STA 102 of FIG. 1. Wireless device 200 includes a controller 210, a BLUETOOTH transceiver 220, a Wi-Fi transceiver 230, and an optional scheduler 250. BLUETOOTH transceiver 220 may transmit and/or receive BLUETOOTH messages, including BLE messages. In some embodiments, BLUETOOTH transceiver 220 may transmit and/or receive BLUETOOTH messages according to a protocol set forth by the BLUETOOTH Special Interest Group. Wi-Fi transceiver 230 may transmit and/or receive Wi-Fi messages. In some embodiments, Wi-Fi transceiver 230 may transmit and/or receive Wi-Fi messages according to an IEEE 802.11 specification. In some embodiments, Wi-Fi transceiver 230 may include a transceiver power controller 232. Transceiver power controller 232 may control power consumption in Wi-Fi transceiver 230 by placing one or more sections of Wi-Fi transceiver 230 into a low-power mode. In one embodiment, analog and/or digital sections of Wi-Fi transceiver 230 associated with transmitting and/or receiving Wi-Fi messages may be placed in the low-power mode by transceiver power controller 232. In another embodiment, transceiver power controller 232 may cause Wi-Fi transceiver 230 to stop broadcasting Wi-Fi beacons and/or to stop listening for Wi-Fi messages transmitted from other wireless devices.

In some embodiments, wireless device 200 may also include scheduler 250. Scheduler 250 may be coupled to Wi-Fi transceiver 230. Scheduler 250 may schedule transmission and reception of Wi-Fi messages between wireless device 200 and other wireless devices (not shown for simplicity). For example, scheduler 250 may schedule Wi-Fi transceiver 230 to transmit and receive Wi-Fi messages through Wi-Fi network 110 during a first time period, and to transmit and receive Wi-Fi messages through P2P network 120 during a second time period.

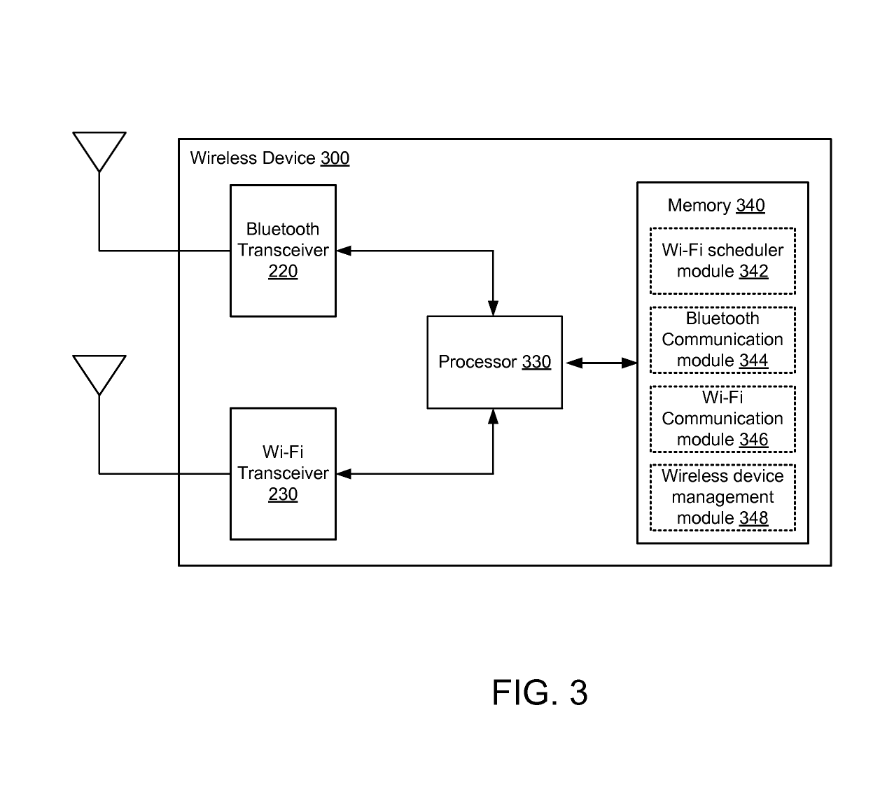

Controller 210 may be coupled to BLUETOOTH transceiver 220, Wi-Fi transceiver 230, and scheduler 250. In some embodiments, controller 210 may control operations of BLUETOOTH transceiver 220 and Wi-Fi transceiver 230. For example, controller 210 may cause Wi-Fi transceiver 230 to transmit Wi-Fi messages including Wi-Fi beacons to other wireless devices. Controller 210 may also cause BLUETOOTH transceiver 220 to transmit one or more BLE messages to other wireless devices. In some embodiments, controller 210 may cause BLUETOOTH transceiver 220 to transmit one or more BLE messages synchronized to Wi-Fi beacons transmitted (e.g., broadcast) by Wi-Fi transceiver 230. In some embodiments, the synchronized BLE message (when received by BLUETOOTH transceiver 220 from another wireless device) may cause sections of wireless device 200 to leave the low-power mode. For example, the synchronized BLE message may cause controller 210 to provide a mode_cntl signal 240 to Wi-Fi transceiver 230. The mode_cntl signal 240 may determine whether Wi-Fi transceiver 230 is to operate in the low-power mode. In another example, controller 210 may cause scheduler 250 to stop scheduling transmission and reception of Wi-Fi messages. Operation of controller 210, BLUETOOTH transceiver 220, Wi-Fi transceiver 230, scheduler 250, and mode_cntl signal 240 is described below in more detail in conjunction with FIGS. 3-6.

FIG. 3 shows a wireless device 300 that is another embodiment of the AP 101 and/or STA 102 of FIG. 1. Wireless device 300 includes BLUETOOTH transceiver 220, Wi-Fi transceiver 230, a processor 330, and a memory 340. BLUETOOTH transceiver 220 and Wi-Fi transceiver 230 may transmit and receive BLUETOOTH and Wi-Fi messages, respectively, as described above in conjunction with FIG. 2. For example, Wi-Fi transceiver 230 may transmit Wi-Fi messages, such as Wi-Fi beacons. BLUETOOTH transceiver 220 may transmit one or more BLE messages, synchronized BLE messages, or other BLUETOOTH signals.

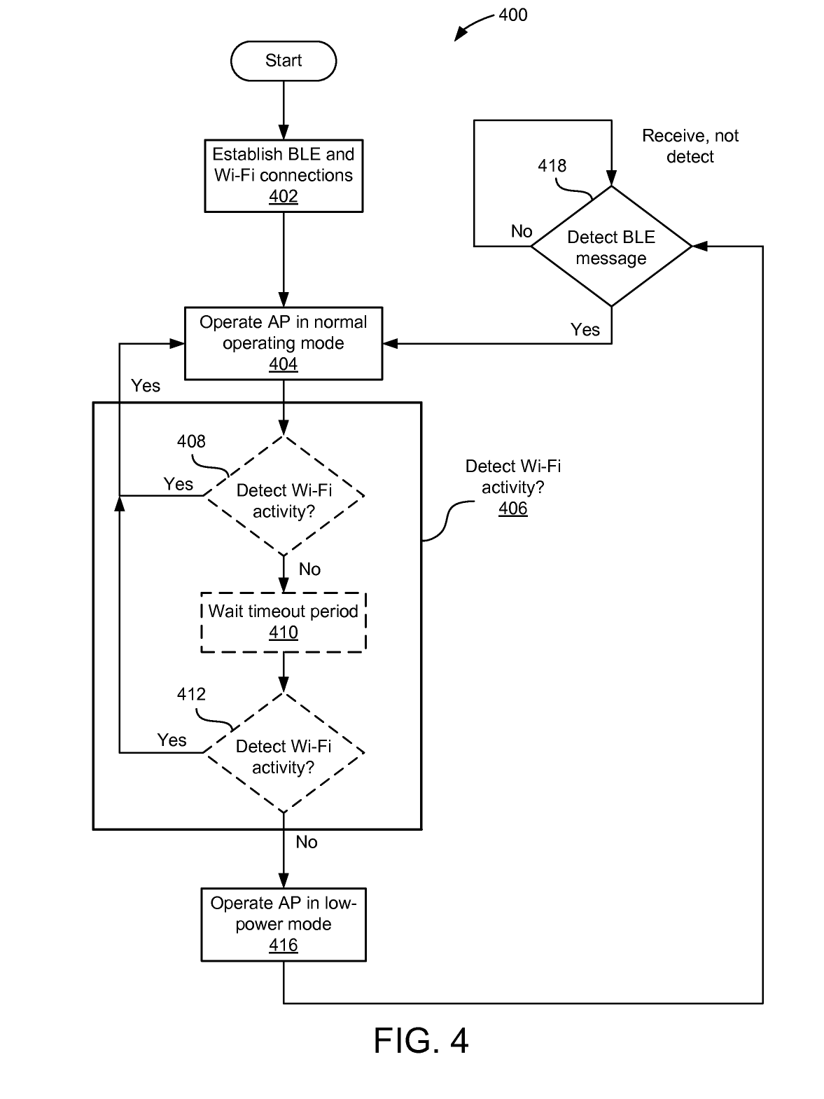

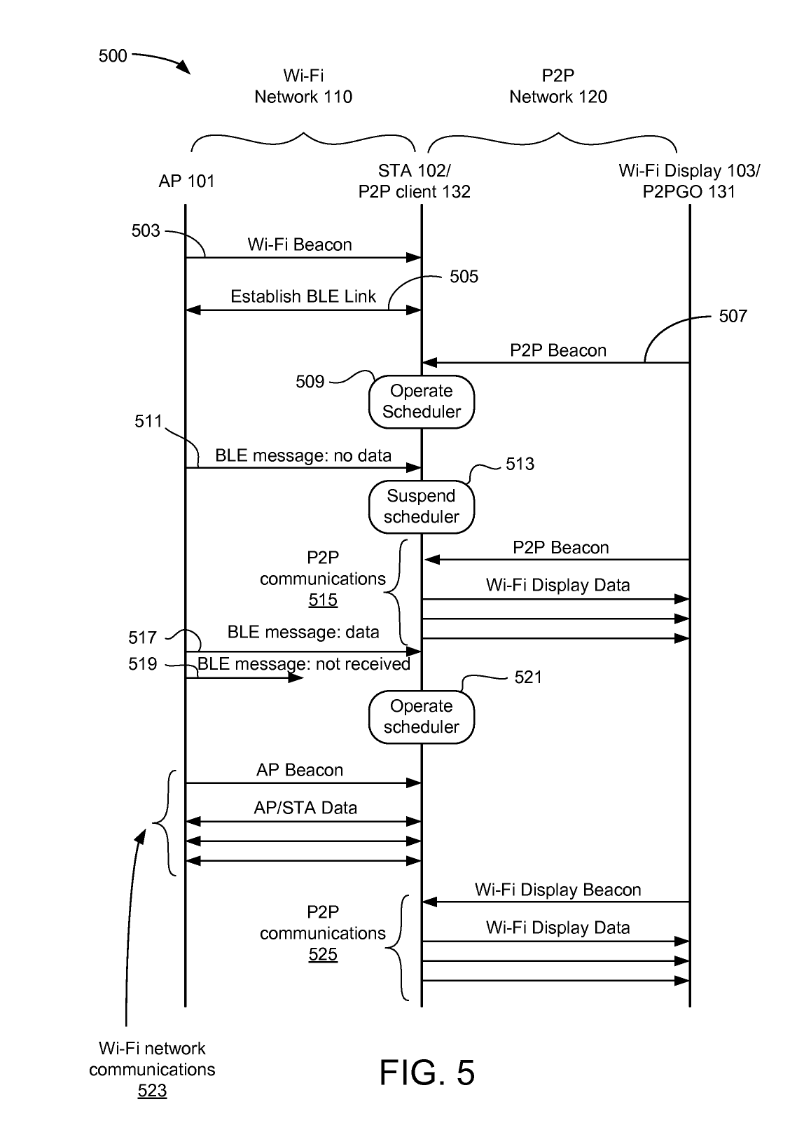

Memory 340 may include a non-transitory computer-readable storage medium (e.g., one or more nonvolatile memory elements, such as EPROM, EEPROM, Flash memory, a hard drive, etc.) that may store the following software modules:
a Wi-Fi scheduler module 342 to schedule Wi-Fi communications to other wireless devices;
a BLUETOOTH communication module 344 to transmit and receive BLUETOOTH and/or BLE messages;
a Wi-Fi communication module 346 to transmit and receive Wi-Fi messages; and
a wireless device management module 348 to manage low-power and normal operating modes of wireless device 300.
   Each software module includes program instructions that, when executed by processor 330, may cause the wireless device 300 to perform the corresponding function(s). Thus, the non-transitory computer-readable storage medium of memory 340 may include instructions for performing all or a portion of the operations of FIGS. 4, 5, and/or 6.

Processor 330, which is coupled to BLUETOOTH transceiver 220, Wi-Fi transceiver 230, and memory 340, may be any suitable processor capable of executing scripts or instructions of one or more software programs stored in the wireless device 300 (e.g., within memory 340).

Processor 330 may execute Wi-Fi scheduler module 342 to schedule Wi-Fi communications between wireless device 300 and other wireless devices (not shown for simplicity). For example, if wireless device 300 is coupled to AP 101 and Wi-Fi display 103, then Wi-Fi scheduler module 342 may schedule wireless device 300 to transmit/receive Wi-Fi messages to/from AP 101 during 30% of an available time period and transmit/receive Wi-Fi messages to/from Wi-Fi display 103 during 35% of the available time period. The remaining 35% of the available time period may be used by wireless device 300 for other tasks, such as radio switching (e.g., frequency switching), and the like. Of course, other portions of the available time period may be allocated for wireless device 300 to communicate with AP 101 and/or Wi-Fi display 103.

Processor 330 may execute BLUETOOTH communication module 344 to transmit and/or receive BLUETOOTH messages, including BLE messages. In some embodiments, BLE messages may consume less power than BLUETOOTH messages. Some BLE messages may include an informational element that may provide status information regarding a wireless device. For example, the informational element may indicate whether AP 101 has data (Wi-Fi messages) for wireless device 300. In another example, another BLE message may include an informational element to indicate that a subsequent Wi-Fi message is directed to a particular wireless device.

Processor 330 may execute Wi-Fi communication module 346 to transmit and/or receive Wi-Fi messages, including Wi-Fi beacons. In some embodiments, Wi-Fi communication module 346 may also detect Wi-Fi activity and control a power mode of Wi-Fi transceiver 230 through transceiver power controller 232 based on detected Wi-Fi activity (see also FIG. 2). In some embodiments, Wi-Fi communication module 346 may enter Wi-Fi transceiver 230 into a low-power mode or a normal operating mode based, at least in part, on informational elements included in BLE messages.

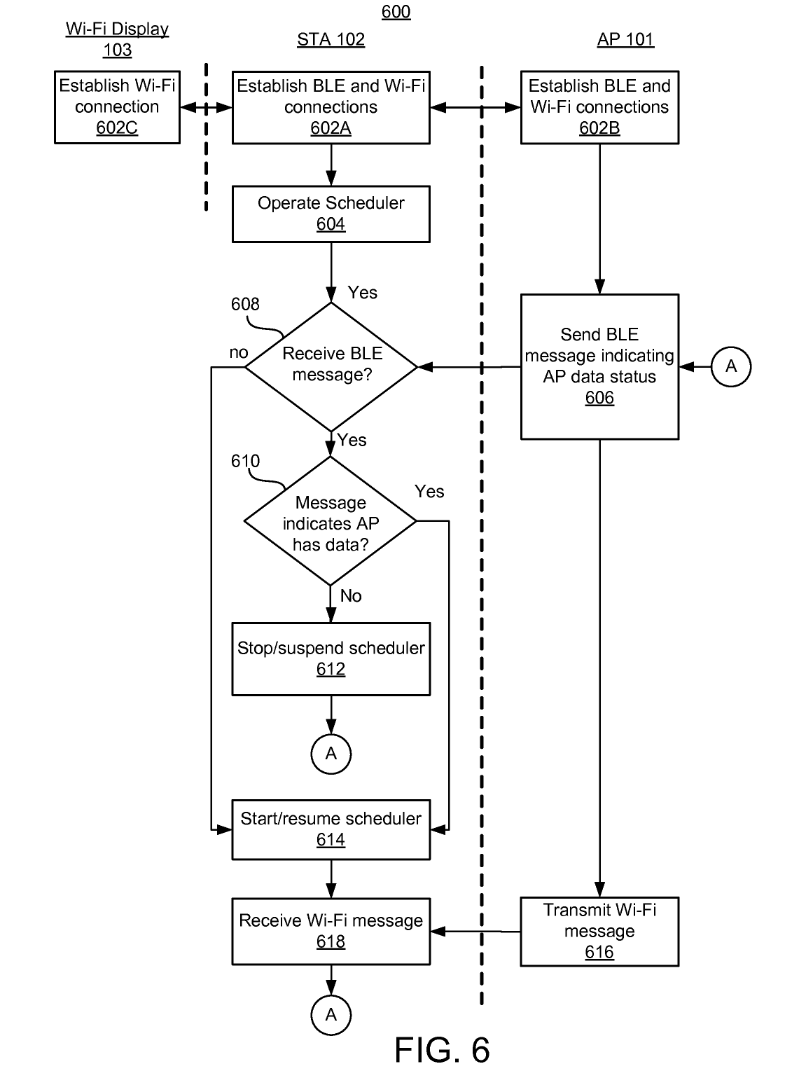

Processor 330 may execute wireless device management module (WDMM) 348 to control at least some operations of BLUETOOTH communication module 344 and/or Wi-Fi communication module 346. In some embodiments, WDMM 348 may synchronize transmission of some BLE messages with Wi-Fi beacons. For example, WDMM 348 may cause BLUETOOTH communication module 344 to transmit a synchronized BLE message to one or more wireless devices prior to when Wi-Fi communication module 346 causes Wi-Fi transceiver 230 to transmit a Wi-Fi beacon. In some embodiments, wireless device 300 may detect Wi-Fi activity (via Wi-Fi communication module 346) and may cause Wi-Fi transceiver 230 to enter a low-power mode as described below in more detail in conjunction with FIG. 4. In some other embodiments, the synchronized BLE message may suspend execution of Wi-Fi scheduler module 342 as described below in more detail in conjunction with FIGS. 5 and 6.

FIG. 4 shows an illustrative flow chart depicting an example operation 400 for operating wireless system 100, in accordance with some embodiments. Some embodiments may perform the operations described herein with additional operations, fewer operations, operations in a different order, operations in parallel, and/or some operations differently. A managing wireless device may manage Wi-Fi network 110 by performing administrative tasks including, for example, transmitting the Wi-Fi beacon. For simplicity, the managing wireless device is referred to as AP 101 in the operation of FIG. 4. In other embodiments, the managing wireless device may be P2PGO 131. AP 101 may reduce its power consumption by entering the low-power mode. For example, while in the low-power mode, portions of AP 101 may be in a low-power state and/or powered off. The low-power mode may be entered when AP 101 does not detect Wi-Fi activity (e.g., Wi-Fi messages from STAs) associated with Wi-Fi network 110. A normal operating mode may be entered (leaving the low-power mode) in response to receiving a BLE message from a STA.

Referring also to FIGS. 1-3, a BLE connection and a Wi-Fi connection are established between AP 101 and STA 102 (402). In some embodiments, Wi-Fi transceivers within AP 101 and STA 102 may exchange Wi-Fi messages to establish the Wi-Fi connection. In other embodiments, STA 102 may join Wi-Fi network 110 managed by AP 101 to establish a Wi-Fi connection. In a similar manner, BLUETOOTH transceivers within AP 101 and STA 102 may exchange BLUETOOTH transceiver information to establish the BLE connection. For example, the BLE connection may be established via passive scans, directed scans, BLUETOOTH messages (including BLUETOOTH advertisement messages), and any other technically feasible procedure to exchange BLUETOOTH transceiver information.

Next, AP 101 enters the normal operating mode (404). In some embodiments, in response to entering the normal operating mode, mode_cntl signal 240 may cause power to be provided to portions of Wi-Fi transceiver 230. For example, in the normal operating mode, analog and digital portions of Wi-Fi transceiver 230 associated with receiving Wi-Fi messages may receive power. In addition, Wi-Fi transceiver 230 may transmit periodic Wi-Fi beacons, and may receive Wi-Fi messages that may be transmitted by other wireless devices in response to receiving the periodic Wi-Fi beacons.

Next, AP 101 detects Wi-Fi activity associated with STA 102 (406). In some embodiments, Wi-Fi activity may be detected by monitoring Wi-Fi messages transmitted to and received from STA 102. If Wi-Fi activity is not detected, then AP 101 enters the low-power mode (416). For example, STA 102 may have moved out of wireless range of AP 101, and Wi-Fi messages (and perhaps BLE messages) may no longer be received from STA 102. In some embodiments, in response to entering the low-power mode, mode_cntl signal 240 may cause power consumption to be reduced by turning off a portion of Wi-Fi transceiver 230 included in AP 101. For example, analog and/or digital portions of Wi-Fi transceiver 230 associated with receiving a Wi-Fi message may be placed in a low-power mode and/or turned off. In some other embodiments, in response to entering the low-power mode, mode_cntl signal 240 may cause Wi-Fi transceiver 230 to cease transmitting Wi-Fi beacons.

Next, AP 101 determines if a BLE message is received from STA 102 (418). In some embodiments, the BLE message may be received when STA 102 comes within a BLE transmission range of AP 101. If the BLE message is not received, then operations proceed to 418. For example, BLE messages may not be received when STA 102 is out of range of AP 101, or STA 102 may be in a low-power mode and is not transmitting Wi-Fi messages. Therefore, AP 101 may remain in the low-power mode and wait to receive a BLE message (e.g. remain at 418). In some embodiments, the BLE message may be synchronized to the Wi-Fi beacon. For example, the BLE message may be transmitted prior to when the Wi-Fi beacon is scheduled to transmitted/received. If a BLE message is received, then operations proceed to 404, and AP 101 enters the normal operating mode.

If Wi-Fi activity is detected (as tested in 406), then operations proceed to 404. In some embodiments, detecting Wi-Fi activity (in 406) may include additional operations. For example, after AP 101 operates in the normal operating mode (in 404), AP 101 detects Wi-Fi activity (408). In some embodiments, Wi-Fi activity may be detected in a manner similar to that described above in conjunction with 406. If Wi-Fi activity is not detected, then AP 101 waits for a timeout period to expire (410). In some embodiments, the timeout period may be a predetermined time period, a time period configured by a user, or a time period determined by a software program. The timeout period may prevent AP 101 from prematurely leaving the normal operating mode. For example, a noisy communication channel may temporarily prevent AP 101 from detecting Wi-Fi activity. Next, AP 101 detects Wi-Fi activity (412). In some embodiments, AP 101 may detect Wi-Fi activity in a manner similar to that described in 406. If Wi-Fi activity is not detected, then operations proceed to 416, and the AP 101 enters the low-power mode. In this manner, a lack of Wi-Fi activity is detected at two separate times, the times separated by the timeout period, before AP 101 enters the low-power mode. If, on the other hand, Wi-Fi activity is detected, then operations proceed to 404.

In some embodiments, a wireless device may be associated with two or more networks at substantially the same time. For example, STA 102 may join Wi-Fi network 110 and communicate with AP 101, and may join P2P network 120 and communicate with Wi-Fi display 103. Communications of STA 102 may be guided, at least in part, by scheduler 250. For example, scheduler 250 may schedule communications between AP 101, Wi-Fi display 103, and STA 102. When a wireless device coupled to STA 102 becomes idle, operations of scheduler 250 may be suspended to provide more bandwidth to other (e.g., non-idle) wireless devices. This is described below in more detail in conjunction with FIGS. 5 and 6.

FIG. 5 shows an example sequence diagram 500 for operating scheduler 250 in a wireless device, in accordance with some embodiments. STA 102 may be coupled to AP 101 through Wi-Fi network 110 and to Wi-Fi display 103 through P2P network 120 at substantially the same time. Communications with wireless devices that are members of Wi-Fi network 110 and wireless devices that are members of P2P network 120 may be scheduled via scheduler 250.

Wi-Fi network 110 may include AP 101 and STA 102. Within Wi-Fi network 110, AP 101 may transmit a Wi-Fi beacon that may be received by STA 102 (503). In some embodiments, both AP 101 and STA 102 may include BLUETOOTH transceivers capable of transmitting and receiving BLE messages. Therefore, a BLE communication link may be established between AP 101 and STA 102 (505).

P2P network 120 may include STA 102 and Wi-Fi display 103. Within P2P network 120, STA 102 may operate as P2P client 132, and may receive a P2P beacon from Wi-Fi display 103 operating as P2PGO 131 (507). In other embodiments, STA 102 may operate as P2PGO 131 and Wi-Fi display 103 may operate as P2P client 132. (Note that P2P beacon is sent from P2PGO 131 to P2P client 132 independent of which particular wireless device operates as P2PGO 131 or P2P client 132). For simplicity, STA 102 is shown in FIG. 5 as a member of two networks. In other embodiments, STA 102 may be a member of any number of networks.

STA 102 may operate scheduler 250 to schedule communications (509). In some embodiments, operations of scheduler 250 may schedule relatively equal time periods to communicate with wireless devices within Wi-Fi network 110 and P2P network 120. For example, scheduler 250 may schedule STA 102 to communicate with AP 101 during 40% of an available time period. Scheduler 250 may also schedule STA 102 to communicate with Wi-Fi display 103 during 40% of the available time period. Any unallocated/unscheduled time left over (in this example 20%) may be used for network overhead, radio switching, and the like. In other embodiments, scheduler 250 may unevenly schedule time periods to communicate with wireless devices within the networks. For example, scheduler 250 may schedule STA 102 to communicate with AP 101 during 50% of an available time period and may schedule STA 102 to communicate with Wi-Fi display 103 during 20% of the available time period. In some embodiments, scheduler 250 may be an adaptive scheduler and may modify scheduled time periods based on network conditions, predicted traffic, and/or any other technically feasible inputs.

As described above, STA 102 may communicate with wireless devices within both Wi-Fi network 110 and P2P network 120. In some cases, however, wireless devices associated with one of the networks may not have data to transfer to/from STA 102. For example, AP 101 may not have data to transmit to or receive from STA 102. If no action is taken, scheduler 250 may schedule time periods to communicate with AP 101, and thereby waste communication bandwidth. In some embodiments, if STA 102 determines that there is no data to transmit to or receive from a particular wireless device, then STA 102 may suspend operation of scheduler 250 and thereby provide more time to communicate with other wireless devices.

For example, AP 101 may send a BLE message to STA 102 to indicate that AP 101 does not have data for STA 102 (e.g., AP 101 has no buffered data for STA 102) (511). In some embodiments, transmission of the BLE message may be synchronized to the Wi-Fi beacon. For example, the BLE message may be transmitted prior to when the Wi-Fi beacon is scheduled to be transmitted. In response to receiving the BLE message indicating that AP 101 does not have data for STA 102, scheduler 250 may be suspended (513). In some embodiments, when scheduler 250 is suspended, time periods normally allocated for communications with a particular wireless device may be used instead for communications with other wireless devices. For example, since the BLE message indicates that AP 101 does not have data for STA 102, STA 102 may use the previously scheduled time period for P2P communications (515).

STA 102 may determine that AP 101 has data to transmit by receiving a BLE message (517). In some embodiments, the BLE message may include an informational element to indicate that AP 101 has data and/or buffered data. In some embodiments, the BLE message may be synchronized. Thus, STA 102 may anticipate receiving the BLE message and may determine when the BLE message is not received. If the BLE message is received indicating that AP 101 has data (517) or if STA 102 determines that the BLE message is not received (519), then scheduler 250 may be operated (521). In some embodiments, if operations of scheduler 250 were previously suspended, then operation of scheduler 250 may be resumed. Operations of scheduler 250 may schedule Wi-Fi network communications (523) and P2P network communications (525). Operating scheduler 250 when the BLE message is missing (shown at 519) may allow STA 102 to receive Wi-Fi messages from AP 101 when the BLE message is not received due to, for example, noisy network conditions. A missing BLE message may be easily detected since an arrival time of the BLE message may be predicted, particularly when the BLE message is synchronized to the Wi-Fi beacon.

FIG. 6 shows an illustrative flow chart depicting another example operation 600 for operating wireless system 100, in accordance with some embodiments. In this example, STA 102 is coupled to AP 101 through Wi-Fi network 110 and is coupled to Wi-Fi display 103 through P2P network 120. Communications with wireless devices that are members of Wi-Fi network 110 and P2P network 120 may be scheduled via scheduler 250. Operations of scheduler 250 may be suspended when STA 102 determines that there is no activity associated with a wireless device from one of the networks. Referring also to FIGS. 1-3 and 5, BLE and Wi-Fi connections are established between STA 102 (602A) and AP 101 (602B). In some embodiments, BLE and Wi-Fi connections may be established in a manner similar to 402 as described above in FIG. 4. A Wi-Fi connection is also established between Wi-Fi display 103 and STA 102 (602C). Thus, STA may communicate with both AP 101 and Wi-Fi display 103.

Next, STA 102 operates scheduler 250 (604). As described above, scheduler 250 may schedule communications (1) between STA 102 and AP 101, and (2) between STA 102 and Wi-Fi display 103. Next, AP 101 sends a BLE message to STA 102 (606). The BLE message may indicate whether there is data, including buffered data, for STA 102 at AP 101. In some embodiments, the BLE message may be synchronized to a Wi-Fi beacon. For example, the BLE message may be transmitted just prior to when the Wi-Fi beacon is transmitted. Next, STA 102 determines if the BLE message is received (608). In some embodiments, the BLE message may be synchronized, and STA 102 may predict when the BLE message may be received. If the BLE message is received, then STA 102 determines if the BLE message indicates that AP 101 has data for STA 102 (610). If the BLE message indicates that AP 101 does not have data, then scheduler 250 is stopped/suspended (612). Since there is no data for STA 102 from AP 101, the scheduler 250 does not need to schedule time periods for Wi-Fi communications to/from AP 101. STA 102 may use time periods previously scheduled for AP 101 to communicate with Wi-Fi display 103. Thus, bandwidth for Wi-Fi messages to/from Wi-Fi display 103 is increased. Operations proceed to 606.

If the BLE message indicates that AP 101 has buffered data for STA 102 (as tested at 610), then operations of scheduler 250 may be started/resumed (614). For example, operations of scheduler 250 may have been stopped/suspended because a previous BLE message indicated that AP 101 had no data for STA 102. Now that a more recent BLE message indicates that AP 101 has data, operations of scheduler 250 may be started/resumed. Next, AP 101 transmits a Wi-Fi message to STA 102 (616). In some embodiments, the Wi-Fi message may include at least some of the data indicated in the BLE message received at 608. Next, STA 102 receives the Wi-Fi message from AP 101 (618). In some embodiments, the Wi-Fi message may be received according to a schedule determined by scheduler 250. Operations proceed to 606.

If the BLE message was not received (as tested at 608), then operations proceed to 614 and operation of scheduler 250 may be started/resumed. If the BLE message is not received (because, for example, there is noise or interference present when trying to receive the BLE message), then STA 102 may start/resume scheduler 250 operations as a precaution so as not to miss Wi-Fi messages that may be sent to STA 102 from AP 101. Since the BLE message may be synchronized, a missing (e.g., not received) BLE message may be relatively easy to detect.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of operating a first wireless device, the method comprising:
establishing a Wi-Fi connection with a second wireless device;
operating the first wireless device in a normal operating mode;
detecting Wi-Fi activity associated with the Wi-Fi connection to the second wireless device; and
leaving the normal operating mode and operating the first wireless device in a low-power mode based, at least in part, on the detected Wi-Fi activity.

2. The method of claim 1, further comprising:
establishing a BLUETOOTH low energy (BLE) connection with the second wireless device;
receiving a BLE message from the second wireless device; and
leaving the low-power mode and operating the first wireless device in the normal operating mode based, at least in part, on the received BLE message.

3. The method of claim 2, wherein the BLE message is synchronized to a Wi-Fi beacon.

4. The method of claim 2, wherein the BLE connection is established via a BLE advertisement message.

5. The method of claim 1, further comprising:
generating a mode control signal based, at least in part, on the detected Wi-Fi activity, wherein an assertion of the mode control signal reduces power consumption of the first wireless device.

6. The method of claim 1, wherein operating the first wireless device in the low-power mode comprises ceasing to transmit Wi-Fi beacons.

7. The method of claim 1, wherein detecting Wi-Fi activity comprises:
waiting a timeout period after not detecting Wi-Fi activity associated with the second wireless device; and
detecting Wi-Fi activity associated with the second wireless device after the timeout period.

8. The method of claim 1, wherein the first wireless device is an access point and the second wireless device is a station.

9. A first wireless device, comprising:
a Wi-Fi transceiver;
a processor; and
a memory storing instructions that, when executed by the processor, causes the first wireless device to:
establish a Wi-Fi connection to a second wireless device;
operate the first wireless device in a normal operating mode;
detect Wi-Fi activity associated with the Wi-Fi connection to the second wireless device; and
leave the normal operating mode and operate the first wireless device in a low-power mode based, at least in part, on the detected Wi-Fi activity.

10. The wireless device of claim 9, further comprising a BLUETOOTH transceiver, wherein execution of the instructions further causes the first wireless device to:
establish a BLUETOOTH low energy (BLE) connection with the second wireless device;
receive a BLE message from the second wireless device; and
leave the low-power mode and operate the first wireless device in the normal operating mode based, at least in part, on the received BLE message.

11. The wireless device of claim 10, wherein the BLE message is synchronized to a Wi-Fi beacon.

12. The wireless device of claim 9, wherein execution of the instructions further causes the first wireless device to:
generate a mode control signal based, at least in part, on the detected Wi-Fi activity, wherein an assertion of the mode control signal reduces power consumption of the first wireless device.

13. The wireless device of claim 9, wherein execution of the instructions to operate the first wireless device in the low-power mode further causes the first wireless device to cease transmitting Wi-Fi beacons.

14. The wireless device of claim 9, wherein execution of the instructions to detect Wi-Fi activity further causes the first wireless device to:
wait a timeout period after not detecting Wi-Fi activity associated with the second wireless device; and
detect Wi-Fi activity associated with the second wireless device after the timeout period.

15. A method of operating a first wireless device, the method comprising:
establishing a BLUETOOTH low energy (BLE) connection with a second wireless device;
establishing a Wi-Fi connection with the second wireless device;
operating a scheduler to schedule Wi-Fi communications between the first wireless device and the second wireless device, and between the first wireless device and a third wireless device;
receiving a BLE message from the second wireless device; and
determining scheduler operation based, at least in part, on the received BLE message.

16. The method of claim 15, wherein the BLE message is synchronized to a Wi-Fi beacon.

17. The method of claim 15, further comprising:
determining whether the received BLE message indicates that there is data for the first wireless device at the second wireless device.

18. The method of claim 15, wherein determining the scheduler operation comprises suspending operation of the scheduler.

19. The method of claim 18, wherein suspending operation of the scheduler stops communications between the first wireless device and the second wireless device.

20. The method of claim 18, further comprising:
resuming operation of the scheduler to schedule Wi-Fi communications when the BLE message is not received.

21. The method of claim 15, further comprising:
establishing a Wi-Fi connection with the third wireless device.

22. The method of claim 15, wherein the BLE message indicates whether there is buffered data for the first wireless device at the second wireless device.

23. The method of claim 15, wherein the first wireless device and the second wireless device are members of a Wi-Fi network, and the first wireless device and the third wireless device are members of a peer-to-peer network.

24. A first wireless device, comprising:
a Wi-Fi transceiver;
a BLUETOOTH transceiver;
a processor; and
a memory storing instructions that, when executed by the processor, causes the first wireless device to:
establish a BLUETOOTH low energy (BLE) connection with a second wireless device;
establish a Wi-Fi connection with the second wireless device;
operate a scheduler to schedule Wi-Fi communications between the first wireless device and the second wireless device, and between the first wireless device and a third wireless device;
receive a BLE message from the second wireless device; and
determine scheduler operation based, at least in part, on the received BLE message.

25. The wireless device of claim 24, wherein the BLE message is synchronized to a Wi-Fi beacon.

26. The wireless device of claim 24, wherein execution of the instructions further causes the first wireless device to:
determine whether the received BLE message indicates that there is data for the first wireless device at the second wireless device.

27. The wireless device of claim 24, wherein execution of the instructions to determine the scheduler operation further causes the first wireless device to suspend operation of the scheduler.

28. The wireless device of claim 27, wherein execution of the instructions to suspend operation of the scheduler further causes the first wireless device to stop communications between the first wireless device and the second wireless device.

29. The wireless device of claim 27, wherein execution of the instructions further causes the first wireless device to resume operation of the scheduler to schedule Wi-Fi communications when the BLE message is not received.

30. The wireless device of claim 24, wherein the BLE message indicates whether there is buffered data for the first wireless device at the second wireless device.
